(19) United States
(12) Patent Application Publication
(10) Pub. No.: US 2026/0237148 A1
(43) Pub. Date: Aug. 13, 2026

(54) PROJECTION-BASED STYLE TRANSFER FOR VOLUMETRIC DATA

(71) Applicants: SONY GROUP CORPORATION, TOKYO (JP); SONY CORPORATION OF AMERICA, NEW YORK, NY (US)

(72) Inventors: ALEXANDRE ZAGHETTO, SAN JOSE, CA (US); DANILLO BRACCO GRAZIOSI, FLAGSTAFF, AZ (US); ALI TABATABAI, CUPERTINO, CA (US)

(21) Appl. No.: 19/051,178

(22) Filed: Feb. 12, 2025

(51) Int. Cl. G06T 15/20; G06T 3/40; G06T 5/70; G06T 7/11; G06T 15/04; G06V 10/25

(52) U.S. Cl. CPC G06T 15/205; G06T 3/40; G06T 5/70; G06T 7/11; G06T 15/04; G06V 10/25; G06T 2207/20084

(57) ABSTRACT

Provided is a system and method for projection-based style transfer for volumetric data. The system acquires three-dimensional (3D) volumetric data and two-dimensional (2D) style image data. Further, the system generates a plurality of 2D projection images based on the acquired 3D volumetric data and prepares an input for a style transfer neural network based on the generated plurality of 2D projection images and the acquired 2D style image data. The system generates a plurality of stylized 2D projection images based on application of the style transfer neural network on the prepared input and obtains a stylized 3D volumetric data based on the plurality of stylized 2D projection images.

### FIELD

Various embodiments of the disclosure relate to volumetric data and neural style transfer. More specifically, various embodiments of the disclosure relate to projection-based style transfer for volumetric data.

### BACKGROUND

Neural Style Transfer (NST) is a fascinating technique in computer vision and deep learning that allows for the reimagining of an image by blending content of the image with the style of another image. This process may leverage convolutional neural networks (CNNs) to extract and recombine the content and style representations of images. Since the pioneering work by Gatys et al. in 2015, numerous methods have been developed to enhance the quality, efficiency, and versatility of style transfer in the 2D domain. These methods range from optimization-based approaches, which produce high-quality results but are computationally intensive, to feed-forward neural networks that offer faster processing times but may sometimes compromise on output quality. However, transferring style in the 3D domain presents a unique set of challenges that may not be as prevalent in 2D image processing. Achieving high-quality style transfer in 3D is more complex due to the additional dimension, which may require maintaining consistency across different views and ensuring that the style is applied uniformly throughout the volumetric data. The computational resources required for 3D style transfer may be significantly higher than those for 2D images, due to the increased amount of data and the complexity of processing volumetric information. Additionally, the creative possibilities in 3D style transfer are still limited. While 2D style transfer may produce a wide range of artistic effects, the same level of versatility has not yet been achieved in 3D. Developing generalizable solutions for 3D style transfer that work across different types of volumetric data, such as 3D imaging, 3D models, and point clouds, remains a significant challenge. Most existing methods are tailored to specific types of data and do not generalize well to others.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

A system and method for projection-based style transfer for volumetric data is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary network environment for projection-based style transfer for volumetric data, in accordance with an embodiment of the disclosure.

FIG. 2 is a block diagram that illustrates an exemplary system of FIG. 1, in accordance with an embodiment of the disclosure.

FIG. 3A is a diagram that illustrates an exemplary flowchart depicting operations for projection-based style transfer for volumetric data, in accordance with an embodiment of the disclosure.

FIG. 3B is a diagram illustrating an exemplary second flowchart depicting the acquisition of 2D style image data associated with distinct types of style images, in accordance with an embodiment of the disclosure.

FIG. 4 is a diagram that illustrates an exemplary block diagram depicting generation of 2D projection images based on a 3D-to-2D projection of 3D patches, in accordance with an embodiment of the disclosure.

FIG. 5 is a diagram illustrating an exemplary flow diagram depicting projection-based style transfer for volumetric data from existing style images, in accordance with an embodiment of the disclosure.

FIG. 6 is a diagram illustrating an exemplary flow diagram depicting projection-based style transfer for volumetric data from generated 2D style images, in accordance with an embodiment of the disclosure.

FIG. 7 is a diagram illustrating an exemplary flow diagram depicting projection-based style transfer for volumetric data based on a selected area, in accordance with an embodiment of the disclosure.

FIG. 8 is a diagram illustrating an exemplary data augmentation executed by the system of FIG. 1, in accordance with an embodiment of the disclosure.

FIG. 9 is a diagram that illustrates an exemplary block diagram depicting execution of projection-based style transfer in gaming, in accordance with an embodiment of the disclosure.

FIG. 10 is a diagram that illustrates an exemplary flow diagram depicting training of 3D Gaussian Splat model, in accordance with an embodiment of the disclosure.

FIG. 11 is a flowchart that illustrates an exemplary method for projection-based style transfer for volumetric data, in accordance with an embodiment of the disclosure.

### DETAILED DESCRIPTION

The following described implementation may be found in a system and a method for projection-based style transfer for volumetric data. Exemplary aspects of the disclosure may provide a system, which may include circuitry that may acquire three-dimensional (3D) volumetric data and two-dimensional (2D) style image data. After the acquisition, the circuitry may generate a plurality of 2D projection images based on the acquired 3D volumetric data and may prepare an input for a style transfer neural network based on the generated plurality of 2D projection images and the acquired 2D style image data. Thereafter, the circuitry may generate a plurality of stylized 2D projection images based on application of the style transfer neural network on the prepared input and may obtain a stylized 3D volumetric data based on the plurality of stylized 2D projection images.

Conventional techniques for style transfer are in a nascent phase and exhibit limited applicability. For example, various solutions have been proposed for style transfer in 2D images. However, style transfer in the 3D domain continues to face numerous challenges that impede quality, efficiency, creative possibilities, and general applicability across different volumetric representations. There are only a few solutions available for style transfer in the 3D domain, and these solutions are neither highly efficient nor broadly applicable. Furthermore, existing solutions vary depending on the type of volumetric data; for instance, the framework architecture used for style transfer in the 3D domain may differ for point cloud applications compared to mesh applications.

The system disclosed herein presents a comprehensive framework architecture for style transfer applicable to all types of volumetric data. This framework may accept inputs in the form of point clouds, meshes, or any other type of volumetric data that may have textures projected onto 2D images. The system may be capable of handling both static (single frame) and dynamic (multi-frame) content. The system may also combine style transfer and generative AI models to apply styles to volumetric data projections.

The system may acquire 3D volumetric data, which may be in the form of point clouds, meshes, or other volumetric data types. Subsequently, the system may acquire 2D style image data, which may include a pre-existing 2D style image, a 2D style image derived from 2D projections of pre-existing 3D volumetric data, or a 2D style image generated through a generative AI tool based on an instruction prompt. This may allow the system to support a wide range of 2D style image data.

The system may then generate a plurality of 2D projection images based on the acquired 3D volumetric data, facilitating the style transfer process, as style transfer on 2D images is well-established. The system may proceed to generate a plurality of stylized 2D projection images by applying a style transfer neural network to an input prepared from the generated 2D projection images and the acquired 2D style image data. This process may enhance the efficiency and time-effectiveness of style transfer. Subsequently, the system may obtain stylized 3D volumetric data based on the plurality of stylized 2D projection images. The resulting stylized 3D volumetric data may be accurate and precisely incorporate the specific style of the 2D style image.

The system may also train a 3D Gaussian Splat model for 3D reconstruction. This process may leverage the strengths of Gaussian splatting to create detailed and accurate 3D models from plurality of 2D images.

The framework's unique characteristics may include the ability to use any 3D to 2D projection technique, such as those employed in Video Point Cloud Coding (V-PCC) for point clouds and Video-Based Dynamic Mesh Coding (V-DMC) for meshes. The framework's compatibility with the V-PCC test model, for instance, makes the framework highly integrable into a typical V-PCC pipeline. In some instances, the framework may be added as an encoder-only tool and activated before the encoding stage of the V-PCC pipeline. Additional image and volume processing modules, whether AI-based or not, may be applied in both the 2D projection domain and the 3D volumetric domain to further enhance quality, improve compression efficiency (if required), or achieve visual adequacy according to the desired style. The framework's flexibility may allow for the transfer of styles from a 2D image to 3D content and from one 3D content to another.

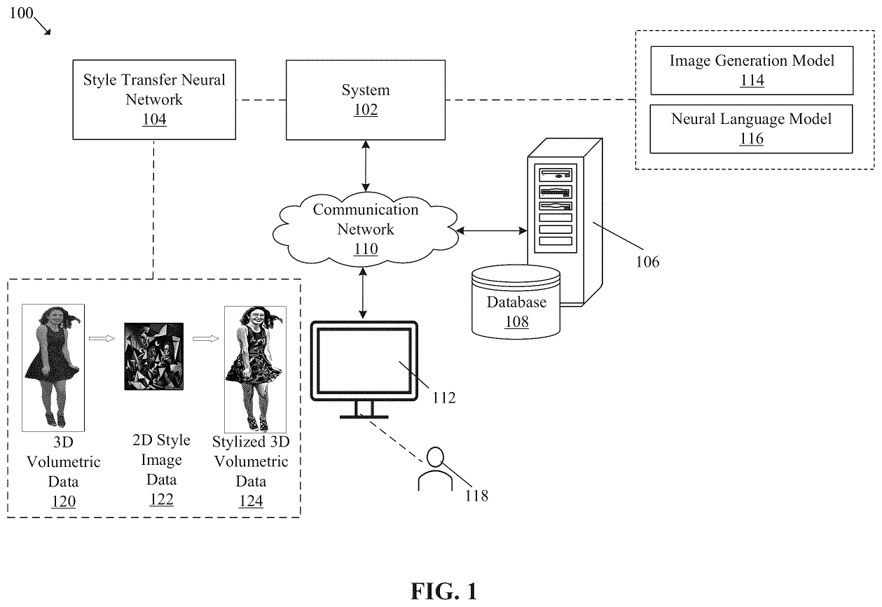

FIG. 1 is a block diagram that illustrates an exemplary network environment for projection-based style transfer for volumetric data, in accordance with an embodiment of the disclosure. With reference to FIG. 1, there is shown a network environment 100. The network environment 100 may include a system 102, a style transfer neural network 104, a server 106, a database 108, a communication network 110, and a user device 112. In FIG. 1, there is further shown an image generation model 114 and a neural language model 116 that may be hosted on the server 106 or the system 102. There is further shown a user 118 who may be associated with the user device 112.

The system 102 may include suitable logic, circuitry, interfaces, and/or code that may be configured to acquire three-dimensional (3D) volumetric data 120 (as shown, for instance, a girl in a frock) in the form of a point cloud, a mesh, or a point cloud sequence. The system 102 may further acquire two-dimensional (2D) style image data 122 (e.g., a 2D style image) and may generate 2D projection images from the 3D volumetric data 120. The system 102 may apply the style transfer neural network 104 on the 2D projection images to stylize the 2D projection images using the 2D style image data 122. The system 102 may reconstruct a stylized 3D volumetric data 124 (as shown, for example, a stylized girl in a frock) from the stylized 2D projection images. Examples of the system 102 may include, but are not limited to, a computing device, a smartphone, a cellular phone, a mobile phone, a gaming device, a wearable device, a mainframe machine, a server, a computer workstation, a smart appliance, and/or a consumer electronic (CE) device.

The system 102 may store the style transfer neural network 104 or may be remotely connected to another system (such as the server 106) that hosts the style transfer neural network 104. When hosted on another system, the system 102 may send instructions to control training or inference of the style transfer neural network 104 via remote calls (e.g., API calls).

The style transfer neural network 104 may include suitable logic, circuitry, interfaces, and/or code that may be configured to perform projection-based style transfer for the 3D volumetric data 120. The style transfer neural network 104 may refer to a type of deep learning model that may be used to transfer artistic style and effects of one image onto another. The style transfer neural network 104 may be initially trained on a dataset of images with different styles. Such images may include pre-existing images, AI-generated images, paintings by artists, and the like. The style transfer neural network 104 may learn to extract and transfer the unique visual characteristics of each style onto new images.

In an embodiment, the style transfer neural network 104 may be referred to as a computational network or a system of artificial neurons, arranged in a plurality of layers, as nodes. The plurality of layers of the neural network may include an input layer, one or more hidden layers, and an output layer. Each layer of the plurality of layers may include one or more nodes (or artificial neurons). Outputs of all nodes in the input layer may be coupled to at least one node of hidden layer(s). Similarly, inputs of each hidden layer may be coupled to outputs of at least one node in other layers of the style transfer neural network 104. Outputs of each hidden layer may be coupled to inputs of at least one node in other layers of the style transfer neural network 104. Node(s) in the final layer may receive inputs from at least one hidden layer to output a result. The number of layers and the number of nodes in each layer may be determined from hyper-parameters of the style transfer neural network 104. Such hyper-parameters may be set before or after training the style transfer neural network 104.

The style transfer neural network 104 may include electronic data, which may be implemented as, for example, a software component of an application executable on the system 102. The style transfer neural network 104 may rely on libraries, external scripts, or other logic/instructions for execution by a processing device, such as the system 102. Further, the style transfer neural network 104 may rely on code and routines to enable a computing device, such as the system 102 to perform one or more operations, such as style transfer. In some embodiments, the style transfer neural network 104 may be implemented using hardware including a processor, a microprocessor (e.g., to perform or control performance of one or more operations), a field-programmable gate array (FPGA), or an application-specific integrated circuit (ASIC). Alternatively, in some embodiments, the style transfer neural network 104 may be implemented using a combination of hardware and software.

The server 106 may include suitable logic, circuitry, and interfaces, and/or code that may be configured to receive the 3D volumetric data 120, the 2D style image data 122, and the stylized 3D volumetric data 124. The server 106 may store the image generation model 114 and the neural language model 116 for inference. The server 106 may be configured to apply the image generation model 114 to generate an image based on a prompt fed by the user 118.

In at least one embodiment, the server 106 may be implemented as a cloud server and may execute operations through web applications, cloud applications, HTTP requests, repository operations, file transfer, and the like. Additionally, or alternatively, the server 106 may be implemented using on-premises hosting (local servers), colocation hosting (third-party data centers), bare metal servers (dedicated servers), edge computing (local data processing), fog computing (decentralized data processing), mesh computing (distributed computing), hybrid cloud (combination of on-premises and cloud), or multi-cloud (multiple cloud providers). Some example implementations of the server 106 may include, but are not limited to, a database server, a file server, a web server, a media server, an application server, a mainframe server, a machine learning server (enabled with or hosting, for example, a computing resource, a memory resource, and a networking resource), or a cloud computing server.

The server 106 may be implemented as a plurality of distributed cloud-based resources by use of several technologies that are well known to those ordinarily skilled in the art. A person with ordinary skill in the art will understand that the scope of the disclosure may not be limited to the implementation of the server 106 and the system 102 as two separate entities. In certain embodiments, the functionalities of the server 106 can be incorporated in its entirety or at least partially in the system 102 without a departure from the scope of the disclosure. In certain embodiments, the server 106 may host the database 108. Alternatively, the server 106 may be separate from the database 108 and may be communicatively coupled to another system that hosts the database 108.

The database 108 may include suitable logic, interfaces, and/or code that may be configured to store references to the acquired 3D volumetric data 120, the acquired 2D style image data 122, and the obtained stylized 3D volumetric data 124. The database 108 may also include references to the generated plurality of 2D projection images, the prepared input, the generated plurality of stylized 2D projection images, and the like. The database 108 may be derived from data off a relational or non-relational database, or a set of comma-separated values (csv) files in conventional or big-data storage. The database 108 may be stored or cached on a device, such as a server (e.g., the server 106) or the system 102. The device storing the database 108 may be configured to receive audio related commands or instructions from the system 102 or the server 106. In response, the device of the database 108 may be configured to retrieve and provide response of the query to the system 102 or the server 106, based on the received query.

In some embodiments, the database 108 may be hosted on a plurality of servers stored at the same or different locations. The operations of the database 108 may be executed using hardware including a processor, a microprocessor (e.g., to perform or control performance of one or more operations), a field-programmable gate array (FPGA), or an application-specific integrated circuit (ASIC). In some other instances, the database 108 may be implemented using software.

The communication network 110 may include a communication medium through which the system 102 and the server 106 may communicate with one another. The communication network 110 may be one of a wired connection or a wireless connection. Examples of the communication network 110 may include, but are not limited to, the Internet, a cloud network, Cellular or Wireless Mobile Network (such as Long-Term Evolution and 5^{th} Generation (5G) New Radio (NR)), satellite communication system (using, for example, low earth orbit satellites), a Wireless Fidelity (Wi-Fi) network, a Personal Area Network (PAN), a Local Area Network (LAN), or a Metropolitan Area Network (MAN). Various devices in the network environment 100 may be configured to connect to the communication network 110 in accordance with various wired and wireless communication protocols. Examples of such wired and wireless communication protocols may include, but are not limited to, at least one of a Transmission Control Protocol and Internet Protocol (TIP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

The user device 112 may include a user-interface through which the user 118 may interact with the system 102, send queries, feed commands and instructions, provide reference images and 3D volumetric data 120 to the system 102. The user 118 may be an authorized person associated with the system 102. The user device 112 may be fixed at a place or may be portable. Examples of the user device 112 may include, but are not limited to a smartphone, a tablet, a graphical user interface (GUI), a personal computer, a voice-activated assistant (e.g., smart speaker), a virtual reality headset, a wearable device (e.g., smartwatch), a smart display, and an augmented reality device.

The image generation model 114 may be defined as a type of neural network designed to create new images based on given inputs, which may be text prompts or reference images. The image generation model 114 may be used to generate synthetic images, which may be used as 2D style image data for neural style transfer, where a style of one image is applied to the content of another. Example architectures used for the image generation model 114 may include, but are not limited to, Generative Adversarial Networks (GANs), Variational Autoencoders (VAEs), Transformers, and Neural Style Transfer Models. GANs consist of two neural networks, a generator, and a discriminator, that may be trained together to produce images indistinguishable from real ones. Examples of GAN architectures may include, but are not limited to, DCGAN (Deep Convolutional GAN) and StyleGAN.

The neural language model 116 may be a machine learning model that may be configured to analyze a prompt and generate a textual response based on the analyzed prompt. The neural language model 116 may be trained on a large dataset of question-answer pairs to interpret human language or other types of complex data. In certain instances, the dataset may be particular to styles of images.

In an embodiment, the neural language model 116 may be a type of an artificial intelligence system (also referred to as an artificial deep neural network) configured to process and understand text and other modalities such as images, audio, 3D data, and video. In an example embodiment, the neural language model 116 may be a large language model, such as a transformer-based decoder-only model, an encoder-decoder model (that uses transformers), or a model that uses neural networks other than transformers.

In some embodiments, the neural language model 116 may include decoders to generate textual responses. During training, the multimodal language model may use large-scale datasets that include paired text inputs. The training may involve techniques like supervised learning, reinforcement learning with human feedback (RLHF), and fine-tuning to ensure the model performs well across different tasks.

As an artificial deep neural network, the neural language model 116 may be referred to as a computational network or a system of artificial neurons in a neural network, arranged in a plurality of layers, as nodes. The plurality of layers of the neural network may include an input layer, one or more hidden layers, and an output layer. Each layer of the plurality of layers may include one or more nodes (or artificial neurons). Outputs of all nodes in the input layer may be coupled to at least one node of hidden layer(s). Similarly, inputs of each hidden layer may be coupled to outputs of at least one node in other layers of the neural network. Outputs of each hidden layer may be coupled to inputs of at least one node in other layers of the neural network. Node(s) in the final layer may receive inputs from at least one hidden layer to output a result. The number of layers and the number of nodes in each layer may be determined from hyper-parameters of the neural network. Such hyper-parameters may be set before or after training the neural network on a training dataset.

Each node of the neural language model 116 may correspond to a mathematical function (e.g., a sigmoid function or a rectified linear unit) with a set of parameters, tunable during training of the network. The set of parameters may include, for example, a weight parameter, a regularization parameter, and the like. Each node may use the mathematical function to compute an output based on one or more inputs from nodes in other layer(s) (e.g., previous layer(s)) of the neural network. All or some of the nodes of the neural network may correspond to the same or a different mathematical function.

In training of the neural language model 116, one or more parameters of each node of the neural network may be updated based on whether an output of the final layer for a given input (from the training dataset) matches a correct result based on a loss function for the neural network. The above process may be repeated for the same or a different input until a minima of loss function is achieved, and a training error is minimized.

The neural language model 116 may include electronic data, which may be implemented as, for example, a software component of an application executable on the electronic device. The neural language model 116 may rely on libraries, external scripts, or other logic/instructions for execution by a processing device. The neural language model 116 may include code and routines configured to enable a computing device, such as the electronic device to perform one or more operations such as the generation of a textual response to an input prompt. Additionally, or alternatively, the neural language model 116 may be implemented using hardware including a processor, a microprocessor (e.g., to perform or control performance of one or more operations), a field-programmable gate array (FPGA), or an application-specific integrated circuit (ASIC). Alternatively, in some embodiments, the neural language model 116 may be implemented using a combination of hardware and software.

In operation, the system 102 may be configured to acquire 3D volumetric data 120 from the server 106, the user device 112, or a 3D scanning system. The 3D scanning system may include, for example, a camera rig for a volumetric capture (e.g., a camera rig in a movie or game studio), a LiDAR sensor onboard a vehicle, or a portable imaging device such as a stereo camera for the volumetric capture. The 3D volumetric data 120 may be associated with a particular field such as 3D imaging, scientific simulations, engineering applications, mapping, navigation, or computed graphics.

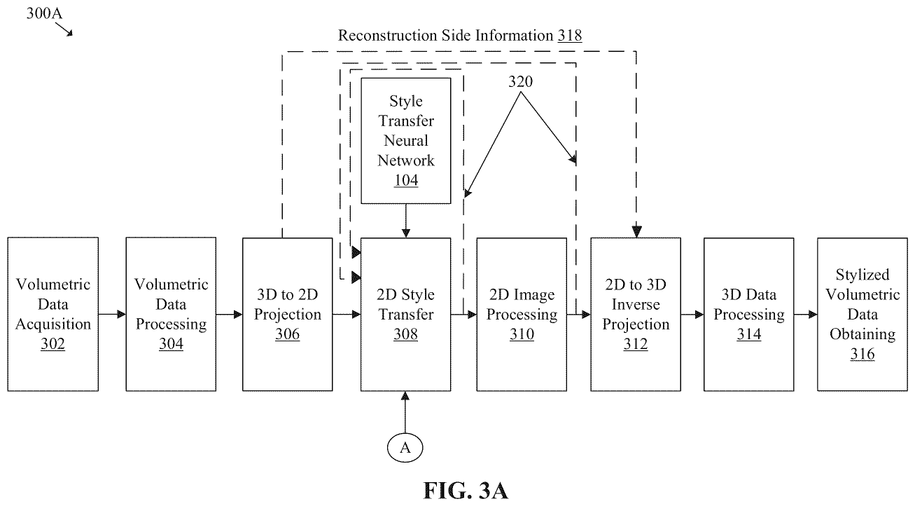

In accordance with an embodiment, the 3D volumetric data 120 may be a static frame of a point cloud or a 3D mesh. As shown, for example, the 3D volumetric data 120 may include a 3D static frame including the girl in the frock. Alternatively, the 3D volumetric data 120 may be a dynamic sequence of multiple point cloud frames or 3D meshes. Further details related to the acquisition of the 3D volumetric data are further described, for example, in 302 of FIG. 3A.

Similar to the 3D volumetric data 120, the system 102 may further acquire 2D style image data 122 from the server 106, the user device 112, or from an application (e.g., a web client) executable on the system 102. The 2D style image data 122 may include at least one image with a specific style, which may be a known style or a computer-generated style. In case of a known style, the 2D style image data 122 may refer to, for instance, paintings of artists, images shot through an imaging device, or digital artwork. In case of a computer-generated style, the 2D style image data 122 may refer to digital images created using various software tools and techniques. These images may include vector graphics, which are defined by mathematical equations and are scalable without losing quality, and raster graphics, which consist of a grid of pixels and are resolution dependent. Additionally, pixel art, characterized by blocky, low-resolution appearance, and digital paintings, which simulate traditional painting techniques may be considered as part of the 2D style image data 122. In some instances, the digital images may be created by feeding a text or image prompt into the image generation model 114. The image generation model 114 may be trained to generate images based on specific prompts with description of a specific style. The description may be used to generate an image with the style or to transform an existing seed image into a specific style image. Further details related to the acquisition of the 3D volumetric data are further described, for example, in FIG. 3B.

After the acquisition of the 3D volumetric data, the system 102 may generate a plurality of 2D projection images based on the acquired 3D volumetric data 120. Each 2D projection image may be a 2D texture map or a 2D geometry image that captures a portion of the 3D color information or geometry information of the acquired 3D volumetric data 120. Additional information such as reconstruction side information 318 (as shown in FIG. 3A) that allows for the reconstruction of the 3D volumetric data 120 data from the plurality of 2D projection images may be also acquired. In some embodiments, each 2D projection may be generated based on patch projection methods of Video Point Cloud Coding (V-PCC) or Video-based Dynamic Mesh Coding (V-DMC). In some other embodiments, the 3D volumetric data 120 may be segment into different 3D patches, which may be projected onto different 2D images, using pre-defined criteria. For instance, the 3D patches may be obtained based on a semantic segmentation of a 3D object (represented by the 3D volumetric data 120), or a user input that provides regions of interest in the 3D object. In some other embodiments, other known techniques used for 3D-2D projection may be used. Such techniques are well known to those ordinarily skilled in the art and therefore, the details of such techniques have been omitted from the disclosure for the sake of brevity.

In an embodiment, the system 102 may be configured to modify the acquired 3D volumetric data 120 based on application of a first set of transformation operations. The first set of transformation operations may include at least one of:
(i) a filtering operation on a 3D geometry of the acquired 3D volumetric data 120 or a texture of the acquired 3D volumetric data 120,
(ii) a down-sampling operation on the 3D geometry of the acquired 3D volumetric data 120 or the texture of the acquired 3D volumetric data 120,
(iii) an up-sampling operation on the 3D geometry of the acquired 3D volumetric data 120 or the texture of the acquired 3D volumetric data 120,
(iv) a segmentation operation on the 3D geometry of the acquired 3D volumetric data 120 or the texture of the acquired 3D volumetric data 120,
(v) a denoising operation on the 3D geometry of the acquired 3D volumetric data 120 or the texture of the acquired 3D volumetric data 120, or
(vi) a completion operation for a reconstruction of missing parts of the 3D geometry of the acquired 3D volumetric data 120 or the texture of the acquired 3D volumetric data 120.

The plurality of 2D projection images may be generated based on the modified 3D volumetric data. Further details related to the generation of the plurality of 2D projection images are further provided, for example, in FIG. 3A.

After the generation, the system 102 may prepare an input for the style transfer neural network 104 based on the generated plurality of 2D projection images and the acquired 2D style image data 122. The preparation of the input may involve various operations such as, but not limited to, preprocessing of the generated plurality of 2D projection images and data augmentation. Details related to the preparation of the input are further described, for example, in FIG. 3A.

The system 102 may be configured to generate the plurality of stylized 2D projection images based on application of the style transfer neural network 104 on the prepared input. The style transfer neural network 104 may combine content of the plurality of 2D projection images with style associated with the acquired 2D style image data 122, resulting in the generation of the plurality of stylized 2D projection images. Each stylized 2D projection image may include an appropriate blend of the content of a respective 2D projection image and the style associated with at least one style image (from the acquired 2D style image data 122).

The style transfer neural network 104 may be capable of handling distinct variations of the prepared input and efficiently perform style transfer. In an embodiment, the style transfer neural network 104 may transfer a single style associated with the acquired 2D style image data to a single 2D projection image. In another embodiment, the style transfer neural network 104 may transfer multiple styles sequentially to one or more 2D projection images of the plurality of 2D projection images through recurrence loops 320 (as shown in FIG. 3A). In another embodiment, the style transfer neural network 104 may apply distinct styles to different 2D projection images of the plurality of 2D projection images that contain different projections of 3D patches of the 3D volumetric data 120.

In an instance, the plurality of 2D projection images and associated 3D patches may be defined through semantic segmentation. In another instance, the plurality of 2D projection images and associated 3D patches may be defined based on selection of region of interests. Along with transferring of the style to the plurality of 2D projection images, the style transfer neural network 104 may also control intensity of the style applied to a specific 2D projection image of the plurality of 2D projection images. In yet another embodiment, the style transfer neural network 104 may transfer a style of one 3D volumetric data to another 3D volumetric data (e.g., 3D volumetric data 120). For example, the style transfer neural network 104 may project texture of a first volumetric data on to a 2D plane, which may further be used as the style the texture of a second volumetric data. Additionally, or alternatively, the style transfer neural network 104 may perform style transfer based on user defined style transfer schemes. Details related to the generation of the plurality of 2D projection images are further described, for example, in 308 and 310 of FIG. 3A.

After the style transfer, the system 102 may be further configured to obtain the stylized 3D volumetric data 124 based on the plurality of stylized 2D projection images. In accordance with an embodiment, the system 102 may be configured to reconstruct an unprocessed 3D volumetric data from the plurality of stylized 2D projection images. The reconstruction may be performed based on the reconstruction side information 318 (acquired after the 3D-2D projection of the 3D volumetric data 120). Thereafter, the system 102 may modify the unprocessed 3D volumetric data based on a second set of transformation operations to obtain the stylized 3D volumetric data 124. The second set of transformation operations may include at least one of:
(i) a filtering operation on a 3D geometry of the unprocessed 3D volumetric data or a texture of the unprocessed 3D volumetric data,
(ii) a down-sampling operation on the 3D geometry of the unprocessed 3D volumetric data or the texture of the unprocessed 3D volumetric data,
(iii) an up-sampling operation on the 3D geometry of the unprocessed 3D volumetric data or the texture of the unprocessed 3D volumetric data,
(iv) a segmentation operation on the 3D geometry of the unprocessed 3D volumetric data or the texture of the unprocessed 3D volumetric data,
(v) a denoising operation on the 3D geometry of the unprocessed 3D volumetric data or the texture of the unprocessed 3D volumetric data, or
a completion operation for a reconstruction of missing parts of the 3D geometry of the unprocessed 3D volumetric data or the texture of the unprocessed 3D volumetric data. The stylized 3D volumetric data 124 may refer to 3D volumetric data that has been transformed by application of an artistic style of a 2D style image. For example, consider a 3D image of a girl in a frock. To stylize the 3D image, the 3D volumetric data 120 may be first projected into a plurality of 2D projection images (or texture maps). These images may be then processed using neural style transfer, where the style of the 2D style image data 122 (such as a painting or texture) may be applied to each 2D projection image. After the stylization, the stylized 2D projection images may be reconstructed back into a stylized 3D volumetric form, which may be a 3D stylized image of the girl in the frock that retains the original shape and structure but exhibits the artistic style of the 2D style image data 122, creating a visually unique and stylized 3D object.

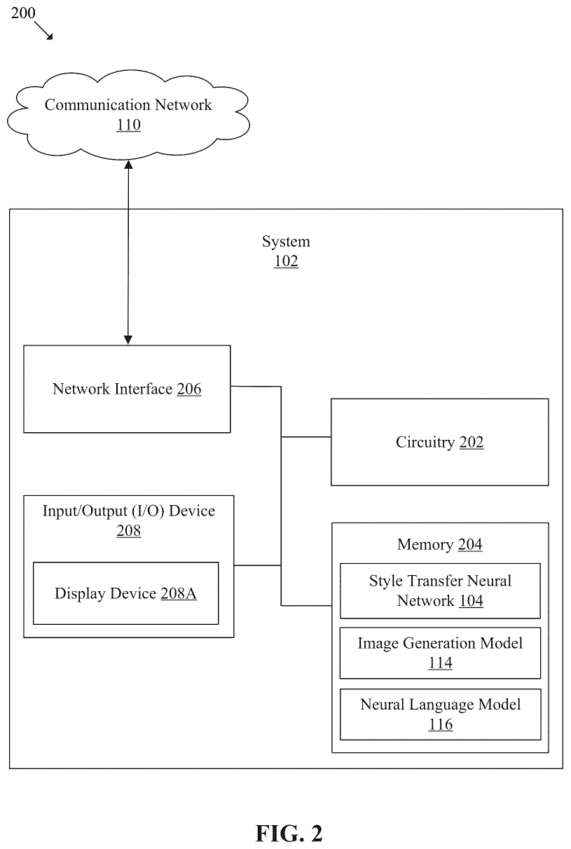

FIG. 2 is a block diagram that illustrates an exemplary system of FIG. 1, in accordance with an embodiment of the disclosure. FIG. 2 is explained in conjunction with elements from FIG. 1. With reference to FIG. 2, there is shown a block diagram 200 of the system 102. The system 102 may include circuitry 202, a memory 204, a network interface 206, and an input/output (I/O) device 208. The I/O device 208 may include a display device 208A, for example. The memory 204 may store the style transfer neural network 104, the image generation model 114, and the neural language model 116. The network interface 206 may connect the system 102 with the server 106, via the communication network 110.

The circuitry 202 may include suitable logic, circuitry, and/or interfaces that may be configured to execute program instructions associated with different operations to be executed by the system 102. The operations may include 3D volumetric data acquisition, 2D style image data acquisition, 2D projection image generation, input preparation, style transfer neural network application, and stylized 3D volumetric data reconstruction. The circuitry 202 may include one or more processing units, which may be implemented as a separate processor. In an embodiment, the one or more processing units may be implemented as an integrated processor or a cluster of processors that perform the functions of the one or more specialized processing units, collectively. The circuitry 202 may be implemented based on a number of processor technologies known in the art. Examples of implementations of the circuitry 202 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The memory 204 may include suitable logic, circuitry, interfaces, and/or code that may be configured to store one or more instructions to be executed by the circuitry 202. The one or more instructions stored in the memory 204 may be configured to execute the different operations of the circuitry 202 (and/or the system 102). The memory 204 may be further configured to store the 3D volumetric data 120, the 2D style image data 122, the plurality of 2D projection images generation, and the stylized 3D volumetric data 124. The memory 204 may also be configured to store the prepared input and the first and second set of transformation operations. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The network interface 206 may include suitable logic, circuitry, interfaces, and/or code that may be configured to facilitate communication between the system 102 and the server 106, via the communication network 110. The network interface 206 may be implemented by use of various known technologies to support wired or wireless communication of the system 102 with the communication network 110. The network interface 206 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

The network interface 206 may be configured to communicate via wireless communication with networks, such as the Internet, an Intranet, a wireless network, a cellular telephone network, a wireless local area network (LAN), or a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5^{th} Generation (5G) New Radio (NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS).

The I/O device 208 may include suitable logic, circuitry, interfaces, and/or code that may be configured to receive an input and provide an output based on the received input. For example, the I/O device 208 may receive an input, from the user 118, related to the 2D style image data. The I/O device 208 may further be configured to render the obtained stylized 3D volumetric data 124 on the user interface, for instance, the user device 112. The I/O device 208 may include the display device 208A. Examples of the I/O device 208 may include, but are not limited to, a display (e.g., a touch screen), a keyboard, a mouse, a joystick, a microphone, or a speaker.

The display device 208A may include suitable logic, circuitry, and interfaces that may be configured to display or render images generated using the image generation model 114. The display device 208A may render the obtained stylized 3D volumetric data 124. The display device 208A may be a touch screen which may enable a user to provide a user-input via the display device 208A. The touch screen may be at least one of a resistive touch screen, a capacitive touch screen, or a thermal touch screen. The display device 208A may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the display device 208A may refer to a display screen of a head mounted device (HMD), a smart-glass device, a see-through display, a projection-based display, an electro-chromic display, or a transparent display. Various operations of the circuitry 202 for performing projection-based style transfer for the 3D volumetric data 120, are described further, for example, in FIG. 3A and FIG. 3B.

FIG. 3A is a diagram that illustrates an exemplary flowchart depicting operations for projection-based style transfer for volumetric data, in accordance with an embodiment of the disclosure. FIG. 3A is explained in conjunction with elements from FIG. 1 and FIG. 2. With reference to FIG. 3A, there is shown an exemplary flowchart 300A that illustrates exemplary operations 302 to 316 for projection-based style transfer for volumetric data. The exemplary operations from 302 to 316 may be executed by any computing system, such as by the system 102 of FIG. 1 or by the circuitry 202 of FIG. 2.

At 302, an operation for volumetric data acquisition may be executed. The circuitry 202 may acquire the 3D volumetric data 120 in the form of point cloud or mesh, which may be received from the server 106, the user device 112, a 3D scanner, or the system 102. In an embodiment, the 3D volumetric data 120 may be in the form of a single frame point cloud. In another embodiment, the 3D volumetric data 120 may be in the form of multi-frame point cloud sequence. In another embodiment, the 3D volumetric data 120 may be in the form of a mesh or any other 3D data format (e.g., voxel format) that allows for projection on 2D planes.

At 304, an operation for volumetric data processing may be executed. The circuitry 202 may process the acquired 3D volumetric data 120 to modify the acquired 3D volumetric data 120. The modification may be based on application of a first set of transformation operations, which may be Artificial Intelligence (AI) based operations or user defined operations. The AI-based set of transformation operations may be independently executed by the circuitry 202 on the acquired 3D volumetric data 120. In contrast, the user-defined set of transformation operations may be selected or defined by the user 118 according to specific requirements or preferences. The first set of transformation operations may include, but is not limited to, the following:
(i) Filtering Operation: This operation may involve applying filters to the 3D geometry or texture of the acquired 3D volumetric data 120 to enhance or suppress certain features. For example, smoothing filters may be used to reduce noise, while sharpening filters may enhance edges and details.
(ii) Down-Sampling Operation: This operation may reduce the resolution of the 3D geometry or texture of the acquired 3D volumetric data 120. Down-sampling may be useful for reducing the computational load and storage requirements by decreasing the number of data points or pixels.
(iii) Up-Sampling Operation: This operation may increase the resolution of the 3D geometry or texture of the acquired 3D volumetric data 120. Up-sampling may be used to create a more detailed representation of the 3D geometry or the texture of the acquired 3D volumetric data 120 data by interpolating additional data points or pixels.
(iv) Segmentation Operation: This operation may involve partitioning the 3D geometry or texture of the acquired 3D volumetric data 120 into distinct regions or segments. Segmentation may be essential for isolating specific structures or features within the data, such as objects in 3D imaging or components in industrial scans. In some instances, each segment or partition of the 3D geometry or the texture may be separately stylized based on a unique style image.
(v) Denoising Operation: This operation may aim to remove noise from the 3D geometry or texture of the acquired 3D volumetric data 120. Denoising may enhance the quality of the acquired 3D volumetric data 120 by eliminating random variations or artifacts that may have been introduced during the acquisition process.
(vi) Completion Operation: This operation may focus on reconstructing missing parts of the 3D geometry or texture of the acquired 3D volumetric data 120. Completion may be crucial for filling in gaps or holes in the data, ensuring a more complete and accurate representation of the original object or scene depicted by the acquired 3D volumetric data 120.
   By applying the first set of transformation operations, the system 102 may effectively modify and enhance the acquired 3D volumetric data 120 to meet specific application requirements for volumetric style transfer and further analysis or visualization.

At 306, an operation for 3D to 2D projection may be executed. The circuitry 202 may generate a plurality of 2D projection images based on the acquired 3D volumetric data 120. In case the acquired 3D volumetric data 120 is modified, the circuitry 202 may utilize the modified 3D volumetric data to generate the plurality of 2D projection images. Each 2D projection image may be a 2D texture map that captures a portion of the 3D color information of the acquired 3D volumetric data 120. Additional information such as reconstruction side information 318 that allows for the reconstruction of the 3D volumetric data 120 from the plurality of 2D projection images may be also acquired.

In some embodiments, each 2D projection may be generated based on patch projection methods of Video Point Cloud Coding (V-PCC) or Video-based Dynamic Mesh Coding (V-DMC). In the case of V-PCC, the 3D volumetric data 120 (e.g., a point cloud) may be divided into connected regions called 3D patches. Each 3D patch may be independently projected onto a 2D patch, functioning like multiple virtual cameras capturing different parts of the 3D volumetric data 120 and combining those images into a mosaic. This process may result in a collection of metadata information associated with the projections, and three associated images (i.e., the plurality of 2D projection images in the form of texture map RGB images). Similarly, if the 3D volumetric data 120 is a 3D mesh, V-DMC may be applied on the 3D mesh for texture map generation. The main difference is that instead of grouping and projecting points, groups of triangles may be projected using techniques like orthographic projections (orthoAtlas) to obtain the plurality of 2D projection images.

In some other embodiments, the 3D volumetric data 120 may be segmented into different 3D patches, which may be projected onto different 2D images using pre-defined criteria. For instance, the 3D patches may be obtained based on a semantic segmentation of a 3D object (represented by the 3D volumetric data 120), or a user input that provides regions of interest in the 3D object. Additionally, other known techniques used for 3D-2D projection may be employed. Such techniques are well known to those ordinarily skilled in the art and therefore, the details of such techniques have been omitted from the disclosure for the sake of brevity.

In some other embodiments, a projection technique may be applied to transform the 3D volumetric data 120 into the plurality of 2D projection images. A virtual camera may be used such that the virtual camera simulates a perspective view of the 3D volumetric data 120. The virtual camera may be positioned and oriented in a specific way to capture desired projections. For each pixel in a 2D projection image of the plurality of 2D projection images, a ray may be cast from the virtual camera into the 3D volumetric data 120. The ray may traverse a volume of the 3D volumetric data 120 and may sample corresponding voxel values along the ray's path. These sampled values may then be used to determine color and intensity of the corresponding pixel in each 2D projection image of the plurality of 2D projection images. A suitable algorithm may be employed to perform the ray casting process, such as the ray marching technique or the voxel-based rendering method. The algorithm may consider factors such as lighting, shading, and transparency to generate visually accurate 2D projections. Finally, post-processing techniques may be applied to enhance the quality and appearance of each 2D projection image of the plurality of 2D projection images. This may involve applying filters, adjusting contrast and brightness, or performing other image processing operations.

At 308, an operation for 2D style transfer may be executed. The circuitry 202 may acquire the 2D style image data 122. In an embodiment, the 2D style image data 122 may include a single style image for the plurality of 2D projection images. In another embodiment, the 2D style image data 122 may include a plurality of style images for each 2D projection image of the plurality of 2D projection images. In another embodiment, the 2D style image data 122 may include a different style image for each 2D projection image of the plurality of 2D projection images. In another embodiment, the 2D style image data 122 may include at least one of a geometric style image, a texture style image, or a style image that may capture a combined geometric and texture style. In another embodiment, the circuitry 202 may acquire a reference 3D volumetric data associated with a specific visual style. Further, the circuitry 202 may generate a reference 2D projection image (e.g., a texture map) from the reference 3D volumetric data. The acquired 2D style image data 122 may include the reference 2D projection image with the specific visual style. Thus, the 2D style image data 122 may include, but not limited to, a 2D projection of an existing volumetric data, a known 2D style image, or a computer-generated style image (e.g., an AI-generated style image, as described in FIG. 3B). After the acquisition, the circuitry 202 may execute 2D style transfer operation through the style transfer neural network 104, as described herein.

The circuitry 202 may prepare an input for the style transfer neural network 104 based on the generated plurality of 2D projection images and the acquired 2D style image data 122. For the preparation of the input, the plurality of 2D projection images may be pre-preprocessed, which involves various operations such as, but not limited to, the following:
(i) resizing the generated plurality of 2D projection images and the acquired 2D style image data 122 to a consistent size to ensure compatibility,
(ii) normalization of pixel values of the plurality of 2D projection images and images associated with the acquired 2D style image data 122 to a common range, such as [0, 1] for better convergence during training, or
(iii) conversion of the images to a suitable format for the style transfer neural network 104, such as tensors or arrays.

Further, the circuitry 202 may combine the plurality of 2D projection images into a single tensor or array. This may be done by stacking the plurality of 2D projection images along a new dimension, creating a multi-channel input. Thereafter, the circuitry 202 may repeat the same process with the acquired 2D style image data 122 to match the number of channels in the tensor or array associated with the combined 2D projection images. This may ensure that the style information is applied consistently across all the 2D projection images. The circuitry 202 may resize the acquired 2D style image data 122 to match the size of the combined projection images. Thereafter, the circuitry 202 may normalize pixel values of the 2D style image data 122 to the same range as that of the combined 2D projection images. The circuitry 202 may concatenate or stack the combined 2D projection images and the normalized 2D style image to create the final input for the style transfer neural network 104. The resulting input should have the appropriate dimensions and channels required by an architecture of the style transfer neural network 104.

The circuitry 202 may generate a plurality of stylized 2D projection images based on application of the style transfer neural network 104 on the prepared input. In an embodiment, multiple styles may be sequentially transferred to one or multiple 2D texture maps (i.e., projection images) through recurrence loops 320. Each loop of the recurrence loops 320 may be associated with at least one style of the multiple styles. The circuitry 202 may perform, in each loop, a sequential transfer of the associated style to at least one of one or more 2D texture maps (i.e., the 2D projection images).

In another embodiment, the circuitry 202 may transfer a style of a first 3D volumetric data to a second 3D volumetric data. For instance, the style transfer neural network 104 may project texture of the first volumetric data on to a 2D plane, which may further be used to style the texture of a second volumetric data (e.g., the 3D volumetric data 120). The circuitry 202 may generate a plurality of 2D projection images for the second volumetric data. The style transfer neural network 104 may generate a plurality of stylized 2D projection images, which may include an appropriate blend of the content of the plurality of 2D projection images and the style associated with the first volumetric data. Further, the circuitry 202 may reconstruct a stylized volumetric data based on the plurality of stylized 2D projection images.

In an embodiment, each 2D projection image of the plurality of 2D projection images may be a texture map corresponding to a 3D patch of the plurality of 3D patches of the 3D volumetric data 120. Different styles may be applied to different 2D texture maps that correspond to different 3D patches of the 3D volumetric data 120 through the recurrence loops 320. In another embodiment, each 2D projection image of the plurality of 2D projection images may be a geometry image corresponding to a 3D patch of the plurality of 3D patches of the 3D volumetric data. The texture maps and associated 3D patches may be defined through semantic segmentation, region of interest selection, and the like. Further, intensity of the style applied to a specific texture map may be controlled.

At 310, an operation for 2D image processing may be executed. The circuitry 202 may be configured to process a plurality of stylized 2D projection images. This processing may involve handling various aspects such as texture or design of these stylized 2D projection images through the application of an image processing operation. The image processing operation may be either Artificial Intelligence (AI)-based or user-defined. Furthermore, the image processing operation may include, but is not limited to, the following:
(i) Filtering Operation: This operation may involve applying filters such as Gaussian blur, median filter, edge detection filter, etc., to the 2D geometry or texture of each 2D projected image. These filters may help in smoothing, sharpening, or detecting edges within the images.
(ii) Enhancement Operation: This operation may focus on improving the visual quality of the images by adjusting parameters such as brightness, contrast, or color balance. The operation may be applied to both the 2D geometry and texture of each projected image to make the images more visually appealing and accurate.
(iii) Morphology Manipulation Operation: This operation may involve manipulating the shape and structure of objects within the images. Functions such as dilation, erosion, opening, or closing may be used to alter the 2D geometry or texture of each projected image. These operations may be essential for refining the shapes and removing noise from the 2D projection images.
(iv) Segmentation Operation: This operation may partition each projected image into meaningful regions or segments based on features such as pixel intensity, color, texture, or AI-based object detection. Segmentation may be crucial for isolating specific areas of interest within the 2D projection images.
(v) Transformation Operation: This operation may include performing geometric transformations such as rotation, scaling, shearing, etc., on the 2D geometry or texture of each projected image. These transformations may be used to adjust the orientation, size, or shape of the 2D projection images.

At 312, an operation for 2D to 3D inverse projection may be executed. The circuitry 202 may reconstruct the 3D volumetric data (such as the stylized 3D volumetric data 124) from the plurality of stylized 2D projection images and the reconstruction side information 318. Typically, the projection of a 3D patch onto a 2D patch acts like a virtual orthographic camera, capturing a specific part of the 3D volumetric data. This 3D volumetric data projection process is analogous to having several virtual cameras registering parts of the 3D volumetric data and combining images from those camera into a mosaic, i.e., an image that contains the collection of projected 2D patches. This process may result in a collection of metadata information associated with the projection of each patch, or analogously, the description of each virtual capture camera. The reconstruction side information 318 may be referred to as the metadata information that may be used to calculate the color and coordinates of the 3D points in the reconstruction of 3D volumetric data.

In some instances, the reconstructed 3D volumetric data may be transformed using one or more 3D data processing operations and may therefore be referred to as unprocessed 3D volumetric data before the transformation.

At 314, an operation for 3D data processing may be executed. The circuitry 202 may process the unprocessed 3D volumetric data. For example, the circuitry 202 may execute a second set of transformation operations including at least one of: (i) a filtering operation on a 3D geometry of the unprocessed 3D volumetric data or a texture of the unprocessed 3D volumetric data, (ii) a down-sampling operation on the 3D geometry of the unprocessed 3D volumetric data or the texture of the unprocessed 3D volumetric data, (iii) an up-sampling operation on the 3D geometry of the unprocessed 3D volumetric data or the texture of the unprocessed 3D volumetric data, (iv) a segmentation operation on the 3D geometry of the unprocessed 3D volumetric data or the texture of the unprocessed 3D volumetric data, (v) a denoising operation on the 3D geometry of the unprocessed 3D volumetric data or the texture of the unprocessed 3D volumetric data, or (vi) a completion operation for a reconstruction of missing parts of the 3D geometry of the unprocessed 3D volumetric data or the texture of the unprocessed 3D volumetric data.

At 316, a stylized volumetric data may be obtained. The circuitry 202 may obtain the stylized 3D volumetric data 124 based on the modification of the unprocessed 3D volumetric data. Alternatively, if the 3D data processing operations are not executed at 314, the reconstructed 3D volumetric data (obtained at 312) may be considered as the stylized 3D volumetric data 124. The stylized 3D volumetric data 124 may be rendered as a 3D image or a 3D video that exhibits a specific artistic or visual style of a single style image or multiple style images included in the 2D style image data.

FIG. 3B is a diagram illustrating an exemplary second flowchart depicting the acquisition of 2D style image data associated with distinct types of style images, in accordance with an embodiment of the disclosure. FIG. 3B is explained in conjunction with elements from FIG. 1, FIG. 2, and FIG. 3A. With reference to FIG. 3B, an exemplary second flowchart 300B illustrates operations from 322 to 330. These operations may be executed by any computing system, such as system 102 of FIG. 1 or circuitry 202 of FIG. 2. Operations 322 to 326 may be executed for acquiring 2D projection of an existing volumetric data. Operation 328 may be executed for acquiring a known 2D style image. Operations 330 to 330 may be executed for acquiring a computer-generated style image.

At 322, an operation for receiving existing volumetric data may be executed. The circuitry 202 may receive volumetric data from user 118 via user device 112, server 106, or database 108. This volumetric data may a pre-existing 3D style image or 3D video.

At 324, an operation for 3D to 2D projection may be executed. The circuitry 202 may generate a plurality of 2D image projections based on the received volumetric data. By way of example, and not limitation, the 3D volumetric data, in case of V-PCC, may be projected into the plurality of 2D projection images by segmenting the 3D volumetric data into smaller 3D patches, projecting such 3D patches onto 2D planes, and creating geometry and/or attribute/texture maps. In case of V-DMC, the 3D volumetric data may be projected into the plurality of 2D projection images by simplifying an input mesh (e.g., the 3D volumetric data or a frame thereof) into a sparser version, parameterizing the mesh onto a 2D texture space, and creating texture maps.

At 326, projected style images may be acquired. The circuitry 202 may acquire 2D projected style images from the plurality of 2D projection images. In this operation, the circuitry 202 may determine and control the intensity, texture, or color of the 2D projection images. The acquired 2D projected style images may be included in the 2D style image data 122, which may be used for 2D style transfer (at 308 of FIG. 3A).

At 328, an operation for receiving known 2D style images may be executed. The circuitry 202 may receive a known 2D style image transmitted via user device 112 or server 106. The known 2D style image may be further included in the 2D style image data 122, which may be used for 2D style transfer (at 308 of FIG. 3A).

At 330, an operation for receiving computer-generated 2D style images may be executed. For instance, a user input 332 in the form of a prompt or instruction may be given by user 118 via user device 112. The prompt may include a textual description of image content with a specific style. The circuitry 202 may apply the image generation model 114 on the user input 332 to generate an image. This process may result in the generation of a synthetic 2D image with the specified content and style at 330. The computer-generated style image may be included in the 2D style image data 122, which may be used for 2D style transfer (at 308 of FIG. 3A).

According to an embodiment, operations 322 to 326 (for acquiring 2D projection of an existing volumetric data), operation 328 (for acquiring a known 2D style image), and operation 330 (for acquiring a computer-generated style image) may be executed independently from one another. According to another embodiment, operations 322 to 326, operation 328, and operation 330 may be executed in a sequence to acquire the 2D style image data 122 that includes distinct types of style images such as, but not limited to, a 2D projection of an existing volumetric data (obtained at 326), a known 2D style image (obtained at 328), or a computer-generated style image such as an AI-generated style image (obtained at 330).

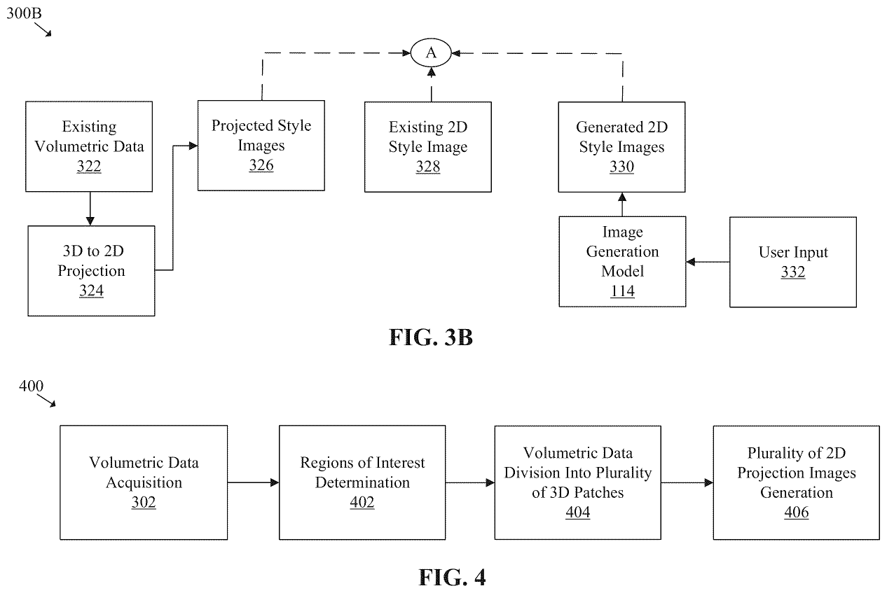

FIG. 4 is a diagram that illustrates an exemplary block diagram depicting generation of 2D projection images based on a 3D-to-2D projection of 3D patches, in accordance with an embodiment of the disclosure. FIG. 4 is explained in conjunction with elements from FIG. 1, FIG. 2, FIG. 3A, and FIG. 3B. With reference to FIG. 4, there is shown an exemplary block diagram 400 that illustrates exemplary operations executed for generation of 2D projection images for 3D patches associated with the 3D volumetric data. The exemplary operations may be executed by any computing system, for example, by the system 102 of FIG. 1 or by the circuitry 202 of FIG. 2.

The circuitry 202 may acquire the 3D volumetric data (as described in FIG. 3A) and may determine regions of interest 402 in the acquired 3D volumetric data 120 based on a user input or a semantic segmentation map of the 3D volumetric data 120. In the semantic segmentation map, a visual representation of the 3D volumetric data 120 may be depicted, where each 3D point of the 3D volumetric data 120 may be assigned a specific label or class. With the help of the semantic segmentation, the 3D volumetric data 120 may be partitioned into meaningful regions of interest 402, and a label may be assigned to each 3D point based on a semantic category to which the 3D point belongs to.

Further, the circuitry 202 may divide the 3D volumetric data 120 into a plurality of 3D patches 404 based on the determined regions of interest 402. To form the plurality of 3D patches 404, the regions of interest 402 of the 3D volumetric data 120 may be divided into smaller sub-volumes or cubes. The size of these cubes, also known as patch size or patch dimensions, may vary depending on the specific application and requirements. The division is typically done in a regular grid-like fashion, where each patch of the plurality of 3D patches 404 has equal dimensions.

The circuitry 202 may further generate the plurality of 2D projection images 406, such that each 2D projection image of the plurality of 2D projection images 406 is generated based on a 3D-to-2D projection of a corresponding 3D patch of the plurality of 3D patches 404 onto an 2D image plane.

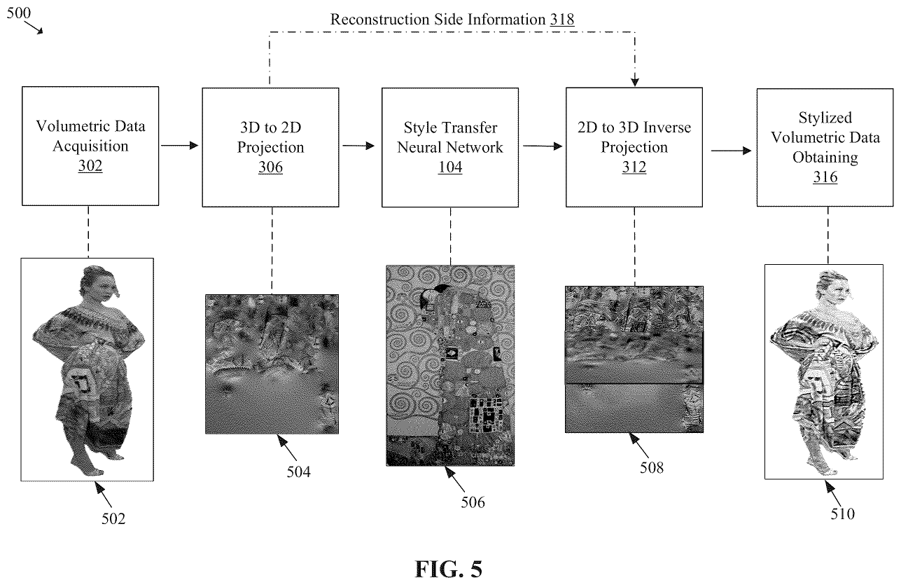

FIG. 5 is a diagram illustrating an exemplary flow diagram depicting projection-based style transfer for volumetric data from existing style images, in accordance with an embodiment of the disclosure. FIG. 5 is explained in conjunction with elements from FIG. 1, FIG. 2, FIG. 3A, FIG. 3B, and FIG. 4. With reference to FIG. 5, an exemplary flow diagram 500 is shown, illustrating operations executed for projection-based style transfer for volumetric data from existing style images. These operations may be executed by any computing system, such as system 102 of FIG. 1 or circuitry 202 of FIG. 2.

The circuitry 202 may acquire the 3D volumetric data, which may be in the form of a point cloud or mesh (as elaborated in 302 of FIG. 3A). As shown, the 3D volumetric data is in the form of point cloud 502 depicting a lady. The point cloud 502 may be processed based on the application of a first set of transformation operations. Details related to the receipt and application of the first set of transformation operations are described in FIG. 3A. Subsequently, the circuitry 202 may generate a plurality of 2D projection images 504 based on the acquired point cloud 502 (as described in FIG. 3A). In an embodiment, the circuitry 202 may process and modify the 3D data of the acquired point cloud 502 before the generation of the plurality of 2D projection images 504. The modified 3D data of the point cloud 502 may be then utilized to generate the plurality of 2D projection images 504.

The circuitry 202 may also acquire the 2D style image data such as a 2D style image 506 having a specific style. The circuitry 202 may execute a 2D style transfer operation through the style transfer neural network 104. For instance, the circuitry 202 may prepare an input for the style transfer neural network 104 based on the generated plurality of 2D projection images 504 and the 2D style image 506. The circuitry 202 may then execute the 2D style transfer operation on the prepared input (as elaborated in 308 of FIG. 3A).

Following this, the circuitry 202 may generate a plurality of stylized 2D projection images 508 based on the execution of the 2D style transfer operation by the style transfer neural network 104 on the prepared input. The circuitry 202 may then reconstruct 3D volumetric data from the plurality of stylized 2D projection images 508 (as elaborated in FIG. 3A). The reconstruction of the 3D volumetric data may be achieved using the plurality of stylized 2D projection images 508 containing stylized texture, along with the reconstruction side information 318.

The circuitry 202 may obtain the 3D volumetric data as stylized 3D volumetric data such as a 3D stylized point cloud 510 depicting the lady (from the acquired point cloud 502) with stylized using the 2D style image 506. If the prepared input includes different style images, the stylized 3D volumetric data 124 may include a plurality of stylized regions, where each stylized region may correspond to a style of a different style image included in the acquired 2D style image data.

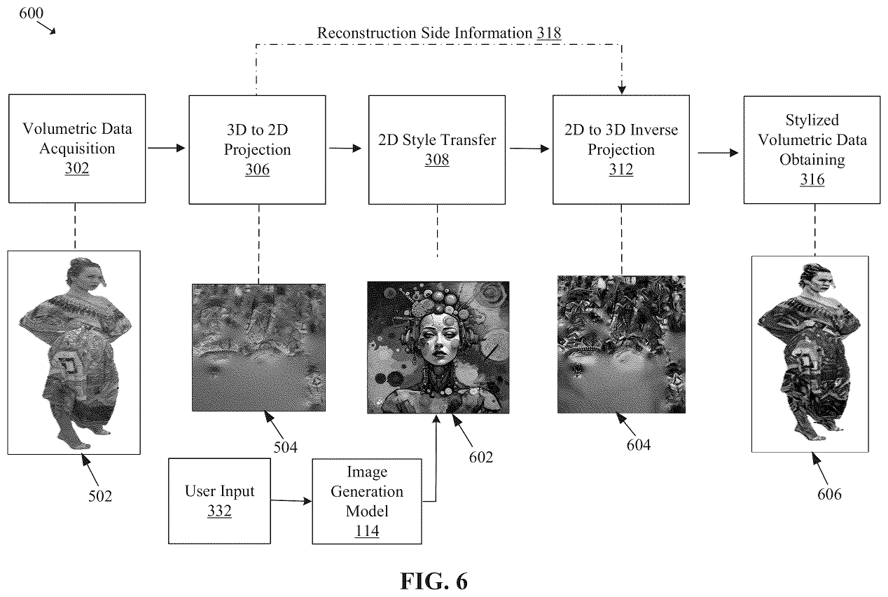

FIG. 6 is a diagram illustrating an exemplary flow diagram depicting projection-based style transfer for volumetric data from generated 2D style images, in accordance with an embodiment of the disclosure. FIG. 6 is explained in conjunction with elements from FIG. 1, FIG. 2, FIG. 3A, FIG. 3B, FIG. 4, and FIG. 5. With reference to FIG. 6, an exemplary flow diagram 600 is shown, illustrating operations executed for projection-based style transfer for volumetric data from generated 2D style images. These operations may be executed by any computing system, such as system 102 of FIG. 1 or circuitry 202 of FIG. 2.

The circuitry 202 may receive an instruction prompt from the user 118 (as elaborated in FIG. 3B). The instruction prompt may be provided by the user 118 via the user device 112. The circuitry 202 may then apply the image generation model 114 to generate an image based on the prompt given by the user 118. For instance, the user 118 may provide an instruction prompt such as, “Create a vibrant image featuring a robot blending Kandinsky's geometric forms and Van Gogh's textured brushstrokes, with expressive elements, resulting in a colorful, immersive artwork that captures the energy and emotion of both artists.” Based on this instruction prompt, the image generation model 114 may create a 2D style image 602 with Kandinsky's geometric forms and Van Gogh's textured brushstrokes.

The circuitry 202 may further prepare an input for the style transfer neural network 104 based on the generated plurality of 2D projection images 504 and the 2D style image 602 (i.e., computer-generated image). The circuitry 202 may then execute the 2D style transfer operation on the prepared input (as elaborated in 308 of FIG. 3A) to generate a plurality of stylized 2D projection images 604. Subsequently, the circuitry 202 may reconstruct 3D volumetric data from the plurality of stylized 2D projection images 604 containing stylized texture and the reconstruction side information 318 (as elaborated in 312 of FIG. 3A). Finally, the circuitry 202 may obtain the stylized 3D volumetric data as the reconstructed 3D volumetric data. As shown, for example, the stylized 3D volumetric data may be a 3D stylized point cloud 606 depicting a stylized lady, incorporating Kandinsky's geometric forms and Van Gogh's textured brushstrokes.

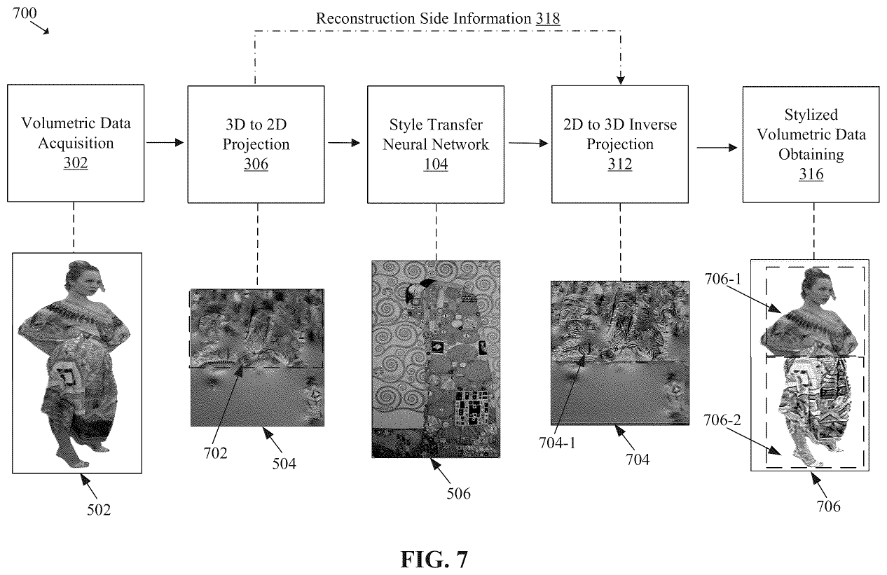

FIG. 7 is a diagram illustrating an exemplary flow diagram depicting projection-based style transfer for volumetric data based on a selected area, in accordance with an embodiment of the disclosure. FIG. 7 is explained in conjunction with elements from FIG. 1, FIG. 2, FIG. 3A, FIG. 3B, FIG. 4, FIG. 5, and FIG. 6. With reference to FIG. 7, an exemplary flow diagram 700 is shown, illustrating operations executed for projection-based style transfer for volumetric data based on a selected area. These operations may be executed by any computing system, such as system 102 of FIG. 1 or circuitry 202 of FIG. 2.

The circuitry 202 may acquire the 3D volumetric data, which may be in the form of a point cloud or mesh (as elaborated in 302 of FIG. 3A). As shown, for example, the 3D volumetric data may be in the form of the point cloud 502 depicting a lady. The point cloud 502 may be processed based on the application of a first set of transformation operations. Details related to the receipt and application of the first set of transformation operations are described in FIG. 3A. Subsequently, the circuitry 202 may generate a plurality of 2D projection images 504 based on the acquired point cloud 502 (as elaborated in 306 of FIG. 3A). In an embodiment, the circuitry 202 may process and modify the 3D data of the acquired point cloud 502. The modified 3D data of the point cloud 502 may be then utilized to generate the plurality of 2D projection images 504. The circuitry 202 may also acquire the 2D style image data such as a 2D style image 506 having a specific style.

Further, the circuitry 202 may further select an area of interest 702 from a 2D projection image of the generated plurality of 2D projection images 504. The circuitry 202 may execute the 2D style transfer operation through the style transfer neural network 104. For instance, the circuitry 202 may prepare an input for the style transfer neural network 104 based on the selected area of interest 702 and the 2D style image 506. The circuitry 202 may also determine an intensity value associated with the 2D style image 506 (included in the acquired 2D style image data). In this case, the prepared input may also include the intensity value along with the 2D style image 506. The circuitry 202 may then execute the 2D style transfer operation on the prepared input (as elaborated in 308 of FIG. 3A). Through the style transfer neural network 104, the circuitry 202 may perform a style transfer from the style image to a corresponding 2D projection image of the plurality of 2D projection images. The style transfer may be performed at the determined intensity value. Following this, the circuitry 202 may generate a plurality of stylized 2D projection images 704 based on the execution of the 2D style operation by the style transfer neural network 104 on the prepared input. Each stylized 2D projected image of the plurality of stylized 2D projection images 704 may include the style of the 2D style image 506 in a portion 704-1 corresponding to the selected area of interest 702.

The circuitry 202 may then reconstruct 3D volumetric data from the plurality of stylized 2D projection images 704 (as elaborated in 312 of FIG. 3A). Further, the circuitry 202 may obtain the stylized 3D volumetric data 124 as the reconstructed 3D volumetric data or after a transformation of reconstructed 3D volumetric data. As shown, for example, the stylized 3D volumetric data may be a 3D stylized point cloud 706 containing a portion 706-1 having the style of the 2D style image 506 and a portion 706-2 retaining the original style.

It should be noted that for the sake of brevity, only one area of interest has been shown in FIG. 7. However, in some embodiments, there may be multiple areas of interest, without limiting the scope of the disclosure.

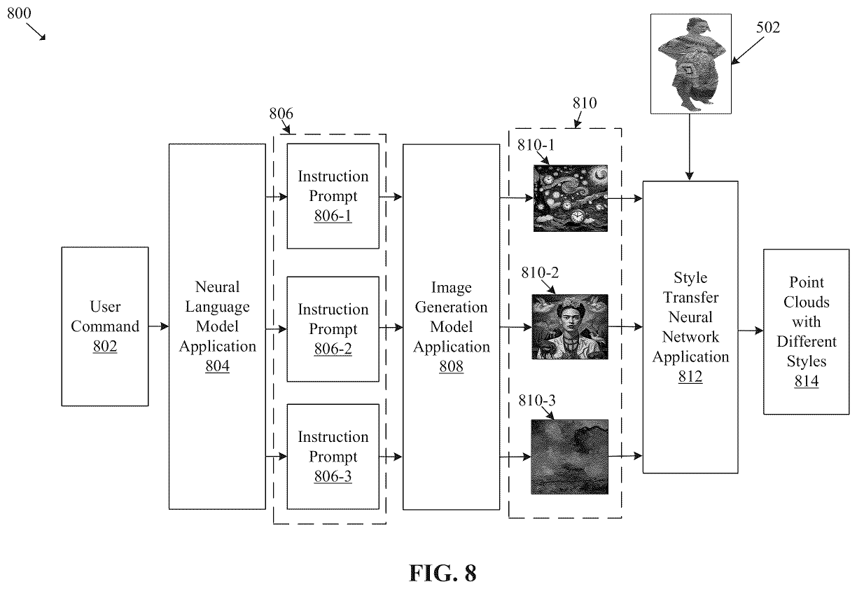

FIG. 8 is a diagram illustrating an exemplary data augmentation executed by the system of FIG. 1, in accordance with an embodiment of the disclosure. FIG. 8 is explained in conjunction with elements from FIG. 1, FIG. 2, FIG. 3A, FIG. 3B, FIG. 4, FIG. 5, FIG. 6, and FIG. 7. With reference to FIG. 8, an exemplary block diagram 800 is shown, illustrating exemplary operations 802 to 814 executed during data augmentation by any computing system, such as the system 102 of FIG. 1 or the circuitry 202 of FIG. 2.

At 802, a command may be provided as an input for the generation of a 2D style image or 3D style volumetric data. The user 118 may provide the command through the user device 112, which may then transmit the command to the circuitry 202.

At 804, the circuitry 202 may receive the transmitted command and may apply the neural language model 116 to the command. For example, the command may be “Create a prompt that fuses the distinctive styles of two renowned painters, alongside a designated painting style and topic, to serve as input for image generation software.”

At 806, the circuitry 202 may generate multiple instruction prompts based on application of the neural language model 116 to the command. For instance, the circuitry 202 may apply the neural language model 116 to the command to generate an instruction prompt 806-1, such as “Fuse the distinctive styles of Vincent van Gogh and Salvador Dalí within a surrealist landscape.” In another instance, the circuitry 202 may generate an instruction prompt 806-2, such as “Merge the distinct styles of Salvador Dalí and Frida Kahlo, using a Surrealist approach, to depict a portrait of resilience.” In another instance, the circuitry 202 may generate an instruction prompt 806-3, such as “Fuse the unique styles of Claude Monet and Wassily Kandinsky, employing an Impressionist abstraction approach, to depict the theme of ‘Harmony in Chaos.”

At 808, the instruction prompt 806-1 may be fed to the image generation model 114, and a corresponding 2D style image 810-1 may be generated as output of the image generation model 114. Similarly, the instruction prompt 806-2 may be fed to the image generation model 114, and a corresponding 2D style image 810-2 may be generated. Similarly, the instruction prompt 806-3 may be fed to the image generation model 114, and a corresponding 2D style image 810-3 may be generated. Subsequently, an input is prepared.

At 810, a 2D style image may be obtained. The prepared input may include the 2D style image along with the point cloud 502 depicting a lady. The 2D style image may include at least one of the generated 2D style images 810-1, 810-2, or 810-3.

At 812, the style transfer neural network 104 may be applied to the prepared input.

At 814, stylized point clouds with different styles may be generated based on the application of the style transfer neural network 104 to the prepared input. Each style may correspond to one of or a combination of the generated 2D style images 810-1, 810-2, or 810-3. Alternatively, stylized meshes may be generated based on the application of the style transfer neural network 104 to the prepared input. The stylized point clouds or stylized meshes may be considered as the stylized 3D volumetric data.

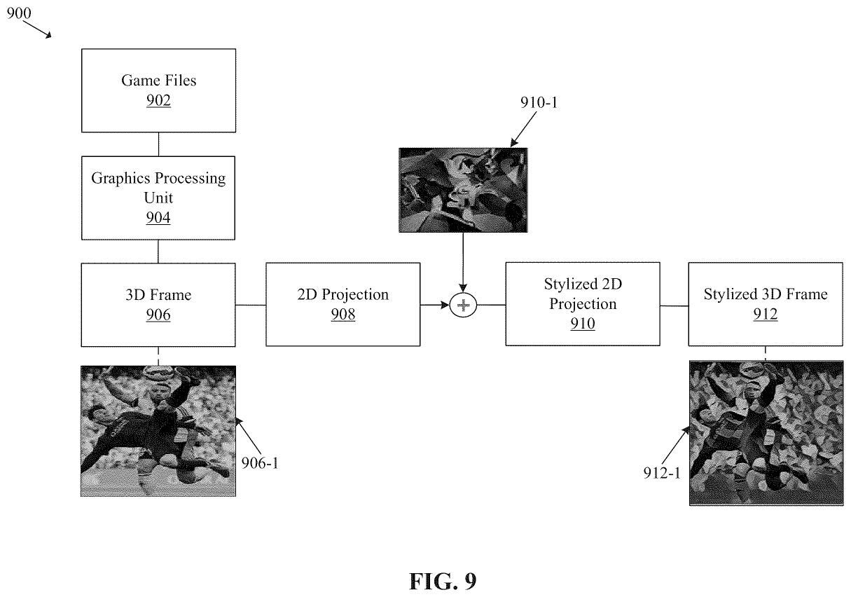

FIG. 9 is a diagram that illustrates an exemplary block diagram depicting execution of projection-based style transfer in gaming, in accordance with an embodiment of the disclosure. FIG. 9 is explained in conjunction with elements from FIG. 1, FIG. 2, FIG. 3A, FIG. 3B, FIG. 4, FIG. 5, FIG. 6, FIG. 7, and FIG. 8. With reference to FIG. 9, there is shown an exemplary block diagram 900 that illustrates execution of exemplary operations 902 to 912 for projection-based style transfer in gaming, by any computing system, for example, by the system 102 of FIG. 1 or by the circuitry 202 of FIG. 2.

At 902, game files may be uploaded into the system 102. Game files refer to the digital assets and data that make up a video game. These files include various elements such as graphics, audio, scripts, levels, character models, and game mechanics. Also, these files may be essential for the functioning and presentation of the video game. Uploading game files typically involves transferring these files from a local storage device to a server or a platform where the video game would be hosted or distributed. The method of uploading game files may vary depending on the platform or distribution method being used.

At 904, the circuitry 202 may process the uploaded game files. In an embodiment, the circuitry 202 may include a Graphics Processing Unit (GPU), which may process graphics related to the uploaded game files. The GPU may efficiently handle and accelerate the rendering of images, videos, and animations. The GPU may process and manipulate graphical data, including rendering 2D and 3D graphics, applying visual effects, and performing calculations related to image and video processing. The GPU may be specifically optimized for parallel processing and handling large amounts of graphical data simultaneously.

At 906, the circuitry 202 may process 3D frames associated with the uploaded game files. For instance, the circuitry 202 may process 3D frame 906-1 depicting two players playing with a ball. The circuitry 202 may extract texture data from the processed 3D frame 906-1.

At 908, the circuitry 202 may generate a plurality of 2D projections (2D projection images) based on the 3D frames. Details related to the generation of the plurality of 2D projection images are further provided, for example, in 306 of FIG. 3A.

At 910, the circuitry 202 may generate stylized 2D projections based on the application of the style transfer neural network 104 on an input. The input may include a 2D stylized image 910-1 including a specific style, and the plurality of 2D projections (generated at 908). In an embodiment, a shader may be used to generate the stylized 2D projection. The shader, in general, may refer to a computer program that may be used to define the visual appearance of objects and surfaces within a game. The shader may be responsible for rendering and manipulating various graphical elements, such as lighting, shadows, textures, and special effects, to create realistic and visually appealing graphics.

At 912, the circuitry 202 may generate a stylized 3D frame based on the generated 2D projections. For example, a stylized 3D frame 912-1 may be generated to depict two players playing with a ball in the style of the 2D stylized image.

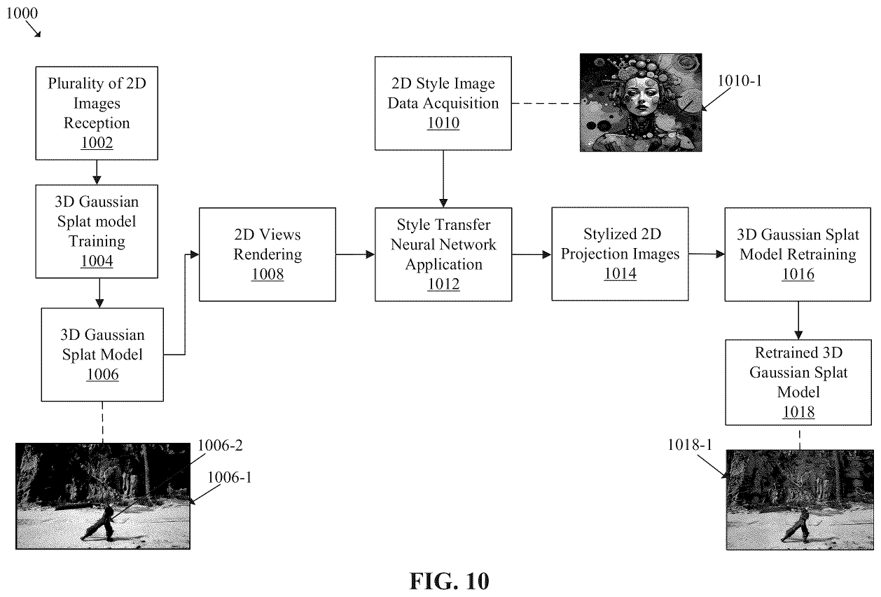

FIG. 10 is a diagram that illustrates an exemplary flow diagram depicting training of 3D Gaussian Splat model, in accordance with an embodiment of the disclosure. FIG. 10 is explained in conjunction with elements from FIG. 1, FIG. 2, FIG. 3A, FIG. 3B, FIG. 4, FIG. 5, FIG. 6, FIG. 7, FIG. 8, and FIG. 9. With reference to FIG. 10, there is shown an exemplary flow diagram 1000 that illustrates execution of exemplary operations from 1002 to 1016 for training of 3D Gaussian Splat model, by any computing system, for example, by the system 102 of FIG. 1 or by the circuitry 202 of FIG. 2.

At 1002, a plurality of 2D images of an object may be received. For example, the object may be a person 1006-2 carrying a sword, as shown in an image 1006-1, The plurality of 2D images may include the person 1006-2 from a plurality of viewpoints. The plurality of 2D images may be obtained from an imaging device, a multi-camera rig, or from a video clip. The 2D images may be obtained such that there is enough coverage and overlap between the 2D images to fully reconstruct the scene with the object (e.g., the person 1006-2).

After reception, the circuitry 202 may generate a 3D representation of the object by processing the plurality of 2D images. For example, the circuitry 202 may use a suitable 3D reconstruction method, such as Multi-View Stereo, 3D photogrammetry, Structure from Motion (SfM), or image-to-3D neural network to generate the 3D representation in form of a point cloud or a 3D mesh. Further, the circuitry 202 may initialize a 3D Gaussian Splat model with Gaussian splats at positions of 3D points of the 3D representation. Each of the Gaussian splats may be a 2D disc in 3D space with parameters such as orientation, color, transparency, and size.

At 1004, the 3D Gaussian Splat model may be trained. The circuitry 202 may train the 3D Gaussian Splat model to optimize the parameters of each of the Gaussian splats. The circuitry 202 may optimize the parameters of each of the Gaussian splats so that the Gaussian splats may better fit the plurality of 2D images. The optimization of the parameters may involve adjusting the position, orientation, and other attributes of at least one of the Gaussian splats such that a difference between the Gaussian splats and the plurality of 2D images is below a threshold.

At 1006, the trained 3D Gaussian Splat model may be obtained. The circuitry 202 may obtain the trained 3D Gaussian Splat model of the object (such as the person 1006-2 carrying the sword). In some instances, the 3D Gaussian Splat model may be referred to as the 3D volumetric data 120 (acquired at 302 of FIG. 3A, for example).

At 1008, 2D views may be rendered. The circuitry 202 may generate the plurality of 2D projection images based on a render of the 2D views from the trained 3D Gaussian Splat model. For instance, once the Gaussian splats are optimized, the circuitry 202 may render the 2D views by projecting the Gaussian splats back into the plurality of 2D projection images. Further, the rendered 2D views may be compared with the obtained plurality of 2D images to validate the accuracy of the 3D Gaussian Splat model.

At 1010, the circuitry 202 may acquire a 2D style image 1010-1 as part of the 2D style image data 122. Further, the circuitry 202 may prepare an input based on the generated plurality of 2D projection images and the acquired 2D style image 1010-1.

At 1012, the style transfer neural network 104 may be applied. The circuitry 202 may apply the style transfer neural network 104 on the prepared input to generate a plurality of stylized 2D projection images 1014.

At 1016, the circuitry 202 may further be configured to retrain the trained 3D Gaussian Splat model based on the plurality of stylized 2D projection images to obtain a retrained 3D Gaussian Splat model 1018, which may be also referred to as stylized 3D volumetric data. As shown, for example, the retrained 3D Gaussian Splat model 1018 may be configured to render a stylized 2D view 1018-1 of the person 1006-2 carrying the sword.

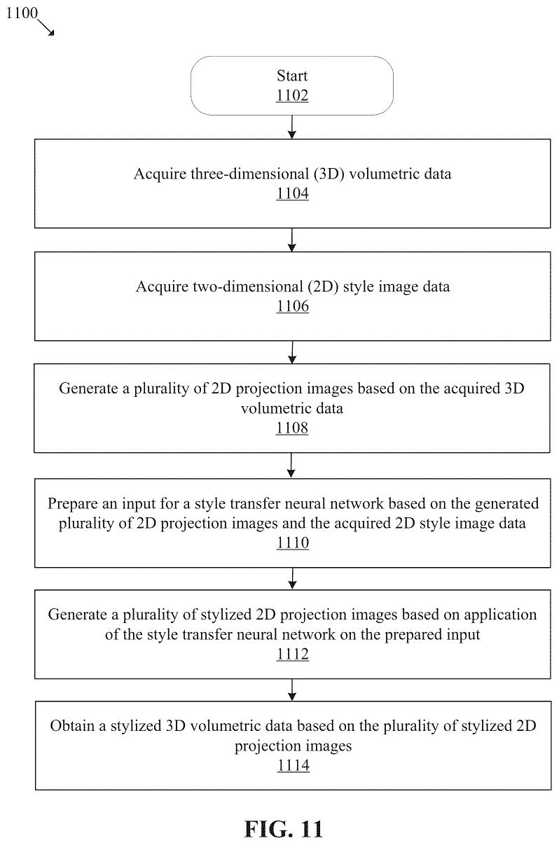

FIG. 11 is a flowchart that illustrates an exemplary method for projection-based style transfer for volumetric data, in accordance with an embodiment of the disclosure. FIG. 11 is explained in conjunction with elements from FIG. 1, FIG. 2, FIG. 3A, FIG. 3B, FIG. 4, FIG. 5, FIG. 6, FIG. 7, FIG. 8, FIG. 9, and FIG. 10. With reference to FIG. 11, there is shown a flowchart 1100. The flowchart 1100 may include operations from 1102 to 1114 and may be implemented by the, for example, by the system 102 of FIG. 1 or by the circuitry 202 of FIG. 2. The flowchart 1100 may start at 1102 and proceed to 1104.

At 1104, 3D volumetric data may be acquired. The circuitry 202 may acquire the 3D volumetric data 120, which may be in the form of point cloud or mesh. Details related to the acquisition of the 3D volumetric data are further described, for example, in 302 of FIG. 3A.

At 1106, 2D style image may be acquired. The circuitry 202 may be configured to acquire the 2D style image. The 2D style image may be pre-existing, derived from 2D projections of a pre-existing 3D volumetric data, or generated through a generative AI tool based on an instruction prompt. Details related to the acquisition of the 3D volumetric data are further described, for example, in FIG. 3B.

At 1108, a plurality of 2D projection images may be generated. The circuitry 202 may be configured to generate the plurality of 2D projection images based on the acquired 3D volumetric data 120. Details related to the generation of the plurality of 2D projection images are further described, for example, in 306 of FIG. 3A.

At 1110, an input may be prepared. The circuitry 202 may be configured to prepare an input for the style transfer neural network 104 based on the generated plurality of 2D projection images and the acquired 2D style image data. Details related to the preparation of the input are further described, for example, in 308 of FIG. 3A.

At 1112, a plurality of stylized 2D projection images may be generated. The circuitry 202 may be configured to generate a plurality of stylized 2D projection images based on application of the style transfer neural network 104 on the prepared input. Details related to the generation of the plurality of 2D projection images are further described, for example, in 310 of FIG. 3A.

At 1114, a stylized 3D volumetric data may be obtained. The circuitry 202 may be configured to obtain a stylized 3D volumetric data 124 based on the plurality of stylized 2D projection images. Details related to the obtaining of the stylized 3D volumetric data 124 are further described, for example, in 316 of FIG. 3A.

Although the flowchart 1100 is illustrated as discrete operations, such as, 1102, 1104, 1106, 1108, 1110, 1112, and 1114, the disclosure is not so limited. Accordingly, in certain embodiments, such discrete operations may be further divided into additional operations, combined into fewer operations, or eliminated, depending on the implementation without detracting from the essence of the disclosed embodiments.

Various embodiments of the disclosure may provide a non-transitory computer-readable medium and/or storage medium having stored thereon, computer-executable instructions executable by a machine and/or a computer to operate a system (for example, the system 102 of FIG. 1). Such instructions may cause the system 102 to perform operations that may include acquisition of 3D volumetric data (for example, the 3D volumetric data 120 of FIG. 1). The operations may further include acquisition of 2D style image data (for example, the 2D style image data 122 of FIG. 1). The operations may further include generation of a plurality of 2D projection images based on the acquired 3D volumetric data 120. The operations may further include preparation an input for a style transfer neural network (for example, the style transfer neural network 104 of FIG. 1) based on the generated plurality of 2D projection images and the acquired 2D style image data 122. The operations may further include generation of a plurality of stylized 2D projection images based on application of the style transfer neural network 104 on the prepared input. The operations may further include obtaining of a stylized 3D volumetric data (for example, the style transfer neural network 104 of FIG. 1) based on the plurality of stylized 2D projection images.

Exemplary aspects of the disclosure may provide a system (such as, the system 102 of FIG. 1) that includes circuitry (such as, the circuitry 202 of FIG. 2). The circuitry 202 may be configured to acquire 3D volumetric data (for example, the 3D volumetric data 120 of FIG. 1). The circuitry 202 may further be configured to acquire 2D style image data (for example, the 2D style image data 122 of FIG. 1). The circuitry 202 may further be configured to generate a plurality of 2D projection images based on the acquired 3D volumetric data 120. The circuitry 202 may further be configured to prepare an input for a style transfer neural network (for example, the style transfer neural network 104 of FIG. 1) based on the generated plurality of 2D projection images and the acquired 2D style image data 122. The circuitry 202 may further be configured to generate a plurality of stylized 2D projection images based on application of the style transfer neural network 104 on the prepared input. The circuitry 202 may further be configured to obtain a stylized 3D volumetric data (for example, the style transfer neural network 104 of FIG. 1) based on the plurality of stylized 2D projection images.

In an embodiment, the circuitry may further be configured to modify the acquired 3D volumetric data 120 based on application of a first set of transformation operations, wherein the plurality of 2D projection images may be generated based on the modified 3D volumetric data.

In an embodiment, the first set of transformation operations include at least one of: a filtering operation on a 3D geometry of the acquired 3D volumetric data or a texture of the acquired 3D volumetric data, a down-sampling operation on the 3D geometry of the acquired 3D volumetric data or the texture of the acquired 3D volumetric data, an up-sampling operation on the 3D geometry of the acquired 3D volumetric data or the texture of the acquired 3D volumetric data, a segmentation operation on the 3D geometry of the acquired 3D volumetric data or the texture of the acquired 3D volumetric data, a denoising operation on the 3D geometry of the acquired 3D volumetric data or the texture of the acquired 3D volumetric data, or a completion operation for a reconstruction of missing parts of the 3D geometry of the acquired 3D volumetric data or the texture of the acquired 3D volumetric data.

In an embodiment, the circuitry 202 may further be configured to determine regions of interest in the acquired 3D volumetric data 120 based on a user input or a semantic segmentation map of the 3D volumetric data 120. The circuitry 202 may further be configured to divide the 3D volumetric data 120 into a plurality of 3D patches based on the determined regions of interest. Each 2D projection image of the plurality of 2D projection images may be generated based on a 3D-to-2D projection of a corresponding 3D patch of the plurality of 3D patches onto an 2D image plane.

In an embodiment, each 2D projection image of the plurality of 2D projection images may be a texture map corresponding to a 3D patch of a plurality of 3D patches of the 3D volumetric data.

In an embodiment, each 2D projection image of the plurality of 2D projection images may be a geometry image corresponding to a 3D patch of a plurality of 3D patches of the 3D volumetric data.

In an embodiment, the 2D style image data 122 may include a style image for the plurality of 2D projection images.

In an embodiment, the 2D style image data 122 may include a plurality of style images for each 2D projection of the plurality of 2D projection images.

In an embodiment, the 2D style image data 122 may include a different style image for each 2D projection of the plurality of 2D projection images.

In an embodiment, the 2D style image data 122 may include at least one of a geometric style image, a texture style image, or a style image that captures a combined geometric and texture style.

In an embodiment, the circuitry 202 may further be configured to acquire a reference 3D volumetric data associated with a specific visual style. The circuitry 202 may further be configured to generate a reference 2D projection from the reference 3D volumetric data. The acquired 2D style image data 122 may include the reference 2D projection with the specific visual style.

In an embodiment, the circuitry 202 may further be configured to determine an intensity value associated with a style image included in the acquired 2D style image data 122. The prepared input may include the intensity value and the style image included in the acquired 2D style image data 122. The style transfer neural network 104 may perform a style transfer from the style image to a corresponding 2D projection image of the plurality of 2D projection images. The style transfer may be performed at the determined intensity value.

In an embodiment, the circuitry 202 may be further configured to acquire a user input comprising a textual description of image content with a specific style. The circuitry 202 may be further configured to generate a synthetic 2D image with the image content based on application of an image generation model on the user input. The acquired 2D style image data 122 may include the generated synthetic 2D image.

In an embodiment, the circuitry 202 may be further configured to process the plurality of stylized 2D projection images based on an image processing operation, wherein the stylized 3D volumetric data may be obtained further based on the processed plurality of stylized 2D projection images.

In an embodiment, the circuitry 202 may be further configured to reconstruct an unprocessed 3D volumetric data from the plurality of stylized 2D projection images. The circuitry 202 may be further configured to modify the unprocessed 3D volumetric data based on a second set of transformation operations to obtain the stylized 3D volumetric data 124. The second set of transformation operations may include at least one of: a filtering operation on a 3D geometry of the unprocessed 3D volumetric data or a texture of the unprocessed 3D volumetric data, a down-sampling operation on the 3D geometry of the unprocessed 3D volumetric data or the texture of the unprocessed 3D volumetric data, an up-sampling operation on the 3D geometry of the unprocessed 3D volumetric data or the texture of the unprocessed 3D volumetric data, a segmentation operation on the 3D geometry of the unprocessed 3D volumetric data or the texture of the unprocessed 3D volumetric data, a denoising operation on the 3D geometry of the unprocessed 3D volumetric data or the texture of the unprocessed 3D volumetric data, or a completion operation for a reconstruction of missing parts of the 3D geometry of the unprocessed 3D volumetric data or the texture of the unprocessed 3D volumetric data.

In an embodiment, the circuitry 202 may further be configured to acquire reconstruction side information (for example, the reconstruction side information 318 of FIG. 3A) based on the plurality of 2D projection images, wherein the unprocessed 3D volumetric data may be reconstructed further based on the reconstruction side information 318.

In an embodiment, the circuitry 202 may further be configured to select an area of interest from a 2D projection image of the generated plurality of 2D projection images. The prepared input may include the selected area of interest and a style image included in the acquired 2D style image data 122. The plurality of stylized 2D projection images may include a stylized 2D projection image corresponding to the selected area of interest.

In an embodiment, the stylized 3D volumetric data 124 may include a plurality of stylized regions, and each stylized region of the plurality of stylized regions may correspond to a different style image included in the acquired 2D style image data 122.

In an embodiment, the circuitry 202 may further be configured to receive a plurality of 2D images of an object from a plurality of viewpoints. The circuitry 202 may further be configured to generate a 3D representation of the object based on the plurality of 2D images. The circuitry 202 may further be configured to initialize a 3D Gaussian Splat model with Gaussian splats at positions of 3D points of the 3D representation, wherein each of the Gaussian splats is a 2D disc in 3D space with parameters. The circuitry 202 may further be configured to train the 3D Gaussian Splat model to optimize the parameters of each of the Gaussian splats such that a difference between the Gaussian splats and the plurality of 2D images is below a threshold. The 3D Gaussian Splat model is the acquired 3D volumetric data, and the generation of the plurality of 2D projection images is based on a render of 2D views from the trained 3D Gaussian Splat model.

In an embodiment, the circuitry 202 may further be configured to retrain the 3D Gaussian Splat model based on the plurality of stylized 2D projection images to obtain the retrained 3D Gaussian Splat model as the stylized 3D volumetric data.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the embodiment disclosed, but that the present disclosure will include all embodiments that fall within the scope of the appended claims.

What is claimed is:

1. A system, comprising:
circuitry configured to:
acquire three-dimensional (3D) volumetric data;
acquire two-dimensional (2D) style image data;
generate a plurality of 2D projection images based on the acquired 3D volumetric data;
prepare an input for a style transfer neural network based on the generated plurality of 2D projection images and the acquired 2D style image data;
generate a plurality of stylized 2D projection images based on application of the style transfer neural network on the prepared input; and
obtain a stylized 3D volumetric data based on the plurality of stylized 2D projection images.

2. The system according to claim 1, wherein the circuitry is further configured to modify the acquired 3D volumetric data based on application of a first set of transformation operations, wherein the plurality of 2D projection images is generated based on the modified 3D volumetric data.

3. The system according to claim 2, wherein the first set of transformation operations include at least one of:
a filtering operation on a 3D geometry of the acquired 3D volumetric data or a texture of the acquired 3D volumetric data,
a down-sampling operation on the 3D geometry of the acquired 3D volumetric data or the texture of the acquired 3D volumetric data,
an up-sampling operation on the 3D geometry of the acquired 3D volumetric data or the texture of the acquired 3D volumetric data,
a segmentation operation on the 3D geometry of the acquired 3D volumetric data or the texture of the acquired 3D volumetric data,
a denoising operation on the 3D geometry of the acquired 3D volumetric data or the texture of the acquired 3D volumetric data, or
a completion operation for a reconstruction of missing parts of the 3D geometry of the acquired 3D volumetric data or the texture of the acquired 3D volumetric data.

4. The system according to claim 1, wherein the circuitry is further configured to:
determine regions of interest in the acquired 3D volumetric data based on a user input or a semantic segmentation map of the 3D volumetric data; and
divide the 3D volumetric data into a plurality of 3D patches based on the determined regions of interest,
wherein each 2D projection image of the plurality of 2D projection images is generated based on a 3D-to-2D projection of a corresponding 3D patch of the plurality of 3D patches onto an 2D image plane.

5. The system according to claim 1, wherein each 2D projection image of the plurality of 2D projection images is a texture map corresponding to a 3D patch of a plurality of 3D patches of the 3D volumetric data.

6. The system according to claim 1, wherein each 2D projection image of the plurality of 2D projection images is a geometry image corresponding to a 3D patch of a plurality of 3D patches of the 3D volumetric data.

7. The system according to claim 1, wherein the 2D style image data includes a style image for the plurality of 2D projection images.

8. The system according to claim 1, wherein the 2D style image data includes a plurality of style images for each 2D projection of the plurality of 2D projection images.

9. The system according to claim 1, wherein the 2D style image data includes a different style image for each 2D projection of the plurality of 2D projection images.

10. The system according to claim 1, wherein the 2D style image data includes at least one of a geometric style image, a texture style image, or a style image that captures a combined geometric and texture style.

11. The system according to claim 1, wherein the circuitry is further configured to:
acquire a reference 3D volumetric data associated with a specific visual style; and
generate a reference 2D projection from the reference 3D volumetric data,
wherein the acquired 2D style image data includes the reference 2D projection with the specific visual style.

12. The system according to claim 1, wherein the circuitry is further configured to determine an intensity value associated with a style image included in the acquired 2D style image data,
wherein the prepared input includes the intensity value and the style image included in the acquired 2D style image data,
the style transfer neural network performs a style transfer from the style image to a corresponding 2D projection image of the plurality of 2D projection images, and
the style transfer is performed at the determined intensity value.

13. The system according to claim 1, wherein the circuitry is further configured to:
acquire a user input comprising a textual description of image content with a specific style; and
generate a synthetic 2D image with the image content based on application of an image generation model on the user input,
wherein the acquired 2D style image data includes the generated synthetic 2D image.

14. The system according to claim 1, wherein the circuitry is further configured to process the plurality of stylized 2D projection images based on an image processing operation, wherein the stylized 3D volumetric data is obtained further based on the processed plurality of stylized 2D projection images.

15. The system according to claim 1, wherein the circuitry is further configured to:
reconstruct an unprocessed 3D volumetric data from the plurality of stylized 2D projection images; and
modify the unprocessed 3D volumetric data based on a second set of transformation operations to obtain the stylized 3D volumetric data,
wherein the second set of transformation operations include at least one of:
a filtering operation on a 3D geometry of the unprocessed 3D volumetric data or a texture of the unprocessed 3D volumetric data,
a down-sampling operation on the 3D geometry of the unprocessed 3D volumetric data or the texture of the unprocessed 3D volumetric data,
an up-sampling operation on the 3D geometry of the unprocessed 3D volumetric data or the texture of the unprocessed 3D volumetric data,
a segmentation operation on the 3D geometry of the unprocessed 3D volumetric data or the texture of the unprocessed 3D volumetric data,
a denoising operation on the 3D geometry of the unprocessed 3D volumetric data or the texture of the unprocessed 3D volumetric data, or
a completion operation for a reconstruction of missing parts of the 3D geometry of the unprocessed 3D volumetric data or the texture of the unprocessed 3D volumetric data.

16. The system according to claim 15, wherein the circuitry is further configured to acquire reconstruction side information based on the plurality of 2D projection images, wherein the unprocessed 3D volumetric data is reconstructed further based on the reconstruction side information.

17. The system according to claim 1, wherein the circuitry is further configured to select an area of interest from a 2D projection image of the generated plurality of 2D projection images,
wherein the prepared input includes the selected area of interest and a style image included in the acquired 2D style image data, and
the plurality of stylized 2D projection images includes a stylized 2D projection image corresponding to the selected area of interest.

18. The system according to claim 1, wherein the stylized 3D volumetric data includes a plurality of stylized regions, and each stylized region of the plurality of stylized regions corresponds to a different style image included in the acquired 2D style image data.

19. The system according to claim 1, wherein the circuitry is further configured to:
receive a plurality of 2D images of an object from a plurality of viewpoints;
generate a 3D representation of the object based on the plurality of 2D images;
initialize a 3D Gaussian Splat model with Gaussian splats at positions of 3D points of the 3D representation, wherein each of the Gaussian splats is a 2D disc in 3D space with parameters;
train the 3D Gaussian Splat model to optimize the parameters of each of the Gaussian splats such that a difference between the Gaussian splats and the plurality of 2D images is below a threshold,
wherein the 3D Gaussian Splat model is the acquired 3D volumetric data, and the generation of the plurality of 2D projection images is based on a render of 2D views from the trained 3D Gaussian Splat model.

20. The system according to claim 19, wherein the circuitry is further configured to retrain the 3D Gaussian Splat model based on the plurality of stylized 2D projection images to obtain the retrained 3D Gaussian Splat model as the stylized 3D volumetric data.

21. A method, comprising:
in a system:
acquiring three-dimensional (3D) volumetric data;
acquiring 2D style image data;
generating a plurality of two-dimensional (2D) projection images based on the acquired 3D volumetric data;
preparing an input for a style transfer neural network based on the generated plurality of 2D projection images and the acquired 2D style image data;
generating a plurality of stylized 2D projection images based on application of the style transfer neural network on the prepared input; and
obtaining a stylized 3D volumetric data based on the plurality of stylized 2D projection images.

22. A non-transitory computer-readable medium having stored thereon, computer-executable instructions that when executed by a system comprising control circuitry, causes the system to execute operations, the operations comprising:
acquiring three-dimensional (3D) volumetric data;
acquiring 2D style image data;
generating a plurality of two-dimensional (2D) projection images based on the acquired 3D volumetric data;
preparing an input for a style transfer neural network based on the generated plurality of 2D projection images and the acquired 2D style image data;
generating a plurality of stylized 2D projection images based on application of the style transfer neural network on the prepared input; and
obtaining a stylized 3D volumetric data based on the plurality of stylized 2D projection images.
